(19) United States
(12) Patent Application Publication
(10) Pub. No.: US 2009/0310859 A1
(43) Pub. Date: Dec. 17, 2009

(54) Automatic color balance control method

(75) Inventors: Kuo-Chin Lien, Chung-Ho (TW); Yung-Chi Chang, Chung-Ho (TW)

Correspondence Address: LIU & LIU, 444 S. FLOWER STREET SUITE 1750, LOS ANGELES, CA, 90071, US

(73) Assignee: VATICS, INC.

(21) Appl. No.: 12/456,173

(22) Filed: Jun. 11, 2009

(30) Foreign Application Priority Data
Jun. 11, 2008 (TW) 097121632

(51) Int. Cl. G06K 9/00; G06K 9/34

(52) U.S. Cl. 382/167; 382/173

(57) ABSTRACT

An automatic color balance control method is used for color balancing an image including a foreground object and a background. The background is extracted from the image by an object detection procedure. Then, the background is analyzed to get the color deviation information. According to the color deviation information, the control method adjusts the gain value to adjust the color value of the image. Accordingly, the present automatic color balance control method can properly adjust the color of the image according to the light source without being affected by the moving foreground objects.

### FIELD OF THE INVENTION

The present invention relates to a color balance control method for color correction, and more particularly to an automatic color balance control method based on background analysis.

### BACKGROUND OF THE INVENTION

Certain types of light cause images captured by image sensors to have a color cast. The color cast is a color deviation phenomenon that colors are not represented in normal intensities. In general, the human eye does not notice the unnatural color because our eyes and brains can adjust and compensate for different types of light in ways that image sensors cannot. The color cast degrades image quality by reducing the saturation of the colors and giving it an overall drab look. Removing the color cast is the most important issue to improve image appearance.

Color cast can be compensated by color balance to recover the normal image. Color balance is the global adjustment of the intensities of the colors (typically red, green, and blue primary colors) to render specific color correctly, particularly neutral color. The general method is sometimes called gray balance, neutral balance, or white balance.

Because an image is formed from the light reflected by objects in a scene, the color of the source lighting is normally what affects color balance. The most used way of achieving color balance is to measure the color of the light source and adjust the image accordingly. Because the eye accommodates, the lighting for any scene should be “white”. Hence, the filter or filter-equivalent adjustment of an image corrects the measured light source to a standard “white”.

For a photographic or videographic apparatus, there are several ways for performing white balance control. The first one is that the user may select the ambient illumination condition manually such as sunlight, shade or incandescent light. The camera has a built-in table recording the mapping between the ambient illumination condition and the gain values. Accordingly, the camera adjusts the color intensities with the gain values obtained from the built-in table. Another option on some cameras is a button which user may press when the camera is pointed at a white region. In addition, some cameras may have automatic white balance function to automatically detect and compensate color cast.

Please refer to FIG. 1, a flowchart illustrating the conventional automatic white balance control method. At the beginning, an image is captured (step 102). Then the camera adjusts color values according to a built-in gain table (step 104). The image with adjusted color values is outputted (step 110). Besides, the method analyzes the color deviation of the outputted image (step 106) and updates the gain value for the next captured image according to the analysis result to decrease the color deviation (step 108).

When objects are moving in and out the frames frequently, the automatic white balance function may count against color correction. The moving objects affect the environment detection of the camera, and continuous variation in light source is detected, but in fact, a stable light source is still provided. The disturbance to the environment detection causes the camera continuously to change the compensation for the color derivation, but the change is unnecessary. Therefore, the conventional automatic white balance control is quite crude.

Consequently, there is a need of providing an improved automatic color balance control method for automatically and properly performing color correction in response to the ambient illumination condition. It is desired that the detection ability is not affected by the moving of objects so that a proper control is made to provide satisfactory color correction.

### SUMMARY OF THE INVENTION

The present invention provides an automatic color balance control method for color balancing an image. At first, the background is extracted from the image by an object detection procedure. Then, the background is analyzed to get the color deviation information. According to the color deviation information, the control method adjusts the gain value to adjust the color value of the image. Accordingly, the control method can properly adjust the color of the image according to the light source by removing the influence of the moving foreground objects.

In an embodiment, the color deviation information of the background is obtained by comparing the background with a color distribution model like a gray world model.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a flowchart illustrating the conventional automatic white balance control method;

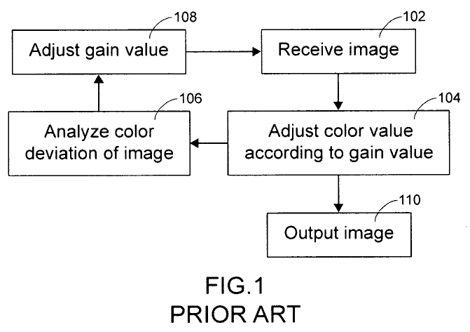

FIG. 2 is a flowchart illustrating a preferred embodiment of an automatic color balance control method according to the present invention; and

FIG. 3 is a block diagram illustrating a possible object detection procedure applied to the automatic color balance control method.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

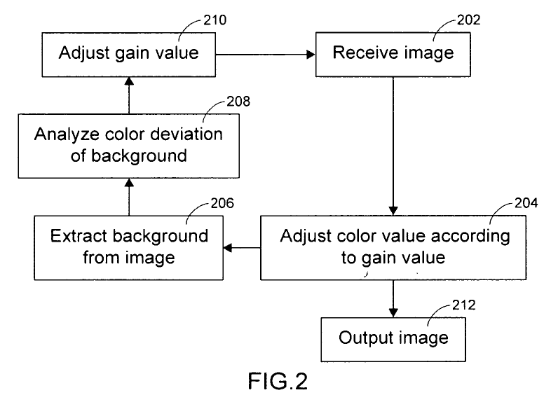

Please refer to FIG. 2, a flowchart illustrating a preferred embodiment of an automatic color balance control method according to the present invention. At the beginning, an image is captured by a digital camera or video camera (step 202). In an embodiment, the image is a digital image. An analog image may be converted into a digital image in advance to be processed in later steps. The control method adjusts the intensities of color values with several gain values (step 204). In an embodiment, the color values are red, green and blue primary color values represented as (R, G, B). The gain values may be obtained from a built-in mapping table, set in the camera, recording the mapping between the ambient illumination condition and the gain values. The gain values give different weightings for primary color values. For example, (R, G, B) is adjusted to (Rx0.7, Gx0.9, Bx0.8) to correct the color deviation. The image with adjusted color values is outputted (step 212). In addition, an object detection procedure is performed to acquire foreground object(s) and background from the corrected image (step 206). Compared with the conventional automatic white balance control method, the present invention analyzes the color deviation of only the background to remove the influence of the foreground object(s) (step 208). In an embodiment, the background is compared with a background color distribution model, for example gray world model, to determine whether the color distribution of the background is as expected. If the color distribution of the background deviates from the background color distribution model, the deviation should be compensated by adjusting the gain values (step 210). For example, if the analysis result indicates that the light source is rich in red light, the method decreases the gain value for red channel. Hence, the next image is adjusted with the new gain values for color correction at step 204.

In another embodiment, if a foreground object is not moving for a period of time, the foreground object may be integrated into the background for the color balance analysis because it can be considered as one part of the background in a sense.

From the above description, it is noted that properly separating the foreground object(s) from the background is essential to the present automatic color balance control method. There are several known approaches for extracting the foreground pixels from the image, for example frame difference, region merge and background subtraction. Since background subtraction has the highest reliability, it may be used for segmenting the foreground object from the image in order to analyze the color balance of the background.

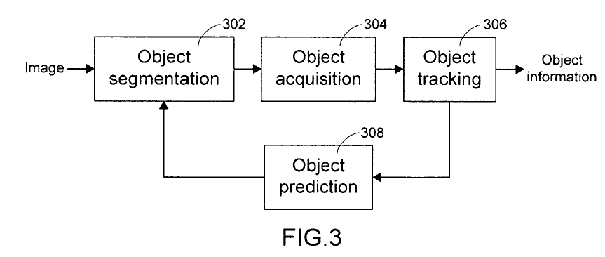

A more reliable procedure to extract foreground object from the image is described herein. This object detection procedure can be applied to the present automatic color balance control method to reach better control performance. Please refer to FIG. 3, a block diagram illustrating the object detection procedure. The object detection procedure includes an object segmentation block 302, an object acquisition block 304, an object tracking block 306 and an object prediction block 308. The object prediction block 308 generates prediction information of foreground objects to indicate the possible positions and sizes of the foreground objects in the next image. Accordingly, the object segmentation block 302 obtains a binary mask by considering the current image and the prediction information of the existing foreground objects. If one pixel is located in the predicted regions of the foreground objects, the object segmentation block 302 increases the probability that the pixel is determined as a foreground pixel in the current image. The pixels in the current image can be assigned with different segmentation sensitivities to obtain a proper binary mask which accurately distinguishes the foreground pixels from the background pixels.

Then, the binary mask is processed by the object acquisition block 304 to collect the features of the foreground pixels and grouping related foreground pixels into foreground objects. A typical method for acquiring foreground objects is connected component labeling algorithm. At this stage, the feature of each segmented foreground object, for example color distribution, center of mass and size, is calculated. At last, the foreground objects in different images are tracked by the object tracking block 306 by comparing the acquired features of corresponding foreground objects in sequential images to realize their changes in appearances and positions. The analysis results are outputted and the object information such as object speed, object species and object interaction is thus received. The analysis results are also processed by the object prediction block 308 to get the prediction information for the segmentation of the next image.

The sensitivity and the threshold value for object segmentation are variable along the entire image. If the pixel is supposed to be a foreground pixel, the threshold value for this pixel decreases to raise the sensitivity of the segmentation procedure. Otherwise, if the pixel is supposed to be a background pixel, the threshold value for this pixel increases to lower the sensitivity of the segmentation procedure.

From the above description, the object prediction information fed back to the object segmentation block 302 affects the controllable threshold value very much. Some object prediction information is explained herein. The object prediction information may include object motion information, object species information, environment information, object depth information, interaction information, etc.

Object motion information includes speed and position of the foreground object. It is basic information associated with other object prediction information.

Object species information indicates the species of the foreground object, for example a car, a bike or a human. It is apparent that the predicted speed is from fast to slow in this order. Furthermore, a human usually has more irregular moving track than a car. Hence, for a human, more historical images are required to analyze and predict the position in the next image.

Environment information indicates where the foreground object is located. If the foreground object is moving down a hill, the acceleration results in an increasing speed. If the foreground object is moving toward a nearby exit, it may predict that the foreground object disappears in the next image and no predict position is provided for the object segmentation block.

Object depth information indicates a distance between the foreground object and the camera. If the foreground object is moving toward the camera, the size of the object becomes bigger and bigger in the following images. On the contrary, if the foreground object is moving away from the camera, the foreground object is of smaller and smaller size.

Interaction information is high-level and more complicated information. For example, one person is moving behind a pillar. The person temporarily disappears in the images. The object prediction block can predict the moving after he appears again according to the historical images before his walking behind the pillar.

The object motion information is taken as an example for further description. The position and motion vector of foreground object k at time t is respectively expressed as Pos(Obj(k), t) and MV(Obj(k), t).

MV(Obj(k), t)=Pos(Obj(k), t)−Pos(Obj(k), t−1) (1)

A motion prediction function MP(Obj(k), t) is defined as:

MP(Obj(k), t)=(MV(Obj(k), t)+MV(Obj(k), t−1)+MV(Obj(k), t−2)+ . . . )_{low}_{_{—}}ₚₐₛₛ (2)

A low pass filter is used in the above equation to filter out the possible noise. Accordingly, the predicted position of the foreground object Predict_pos(Obj(k), t+1) may be obtained by adding the motion prediction function to the current position as the following equation:

Predict_pos(Obj(k), t+1)=Pos(Obj(k), t)+MP(Obj(k), t) (3)

Thus, pixels within the prediction region of the foreground object are preliminarily considered as foreground pixels.

This object detection procedure utilizes the prediction information of foreground objects to facilitate the segmentation determination of the pixels. The variable threshold value flexibly adjusts the segmentation sensitivities along the entire image so as to increases the accuracy of object segmentation. It is particularly applicable to the present automatic color balance control method because of the accurate object detection ability.

In summary, the present automatic color balance control method takes advantage of object detection technique to distinguish the foreground object from the background. The method analyzes the color balance of the background rather than the entire image. Hence, the present control method can accurately determine the color deviation resulting from the light source without analyzing the moving objects. Since the background does not considerably vary for a period of time, the variation in background color truly reflects the variation in the light source. Under stable light source, fluctuation in image color is thus avoided even though objects appear and disappear in a short time.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic color balance control method for color balancing an image comprising at least one foreground object and a background, comprising steps of:
extracting the background from a first image;
analyzing a color deviation of the background;
adjusting a gain value according to the color deviation; and
adjusting a color value of a second image later than the first image according to the gain value.

2. The automatic color balance control method according to claim 1 wherein before the extracting step, the method further comprises a step of adjusting another color value of the first image according to another gain value obtained from a mapping table.

3. The automatic color balance control method according to claim 1 wherein the analyzing step comprises a step of comparing a color distribution of the background with a color distribution model.

4. The automatic color balance control method according to claim 3 wherein the color distribution model is a gray world model.

5. The automatic color balance control method according to claim 1 wherein the color value includes a red value, a green value and a blue value.

6. The automatic color balance control method according to claim 1 wherein the extracting step is performed by a background subtraction approach.

7. The automatic color balance control method according to claim 1 wherein the automatic color balance control method is an automatic white balance control method for adjusting white color of the image to standard white.

8. The automatic color balance control method according to claim 1 wherein the extracting step further comprises steps of:
receiving prediction information of the foreground object;
adjusting a segmentation sensitivity for each pixel according to the prediction information;
for each pixel, determining whether the pixel is a foreground pixel or a background pixel according to a property of the pixel by considering the segmentation sensitivity corresponding to the pixel; and
grouping a plurality of related foreground pixels into the foreground object.

9. The automatic color balance control method according to claim 8 wherein the prediction information indicates that a portion of pixels in the image are predicted foreground pixels.

10. The automatic color balance control method according to claim 9 wherein the segmentation sensitivity of a selected pixel increases when the selected pixel is one of the predicted foreground pixels.

11. The automatic color balance control method according to claim 9 wherein the segmentation sensitivity of a selected pixel decreases when the selected pixel is not one of the predicted foreground pixels.

12. The automatic color balance control method according to claim 8, further comprising a step of calculating object information of the foreground object.

13. The automatic color balance control method according to claim 12 wherein the object information is one selected from a group consisting of color distribution, center of mass, size and a combination thereof.

14. The automatic color balance control method according to claim 13 wherein the foreground object is tracked according to a change in the object information between different images to get motion information of the foreground object.

15. The automatic color balance control method according to claim 14 wherein the motion information includes moving speed and moving direction of the foreground object.

16. The automatic color balance control method according to claim 14 wherein the prediction information of the foreground object is generated according to the motion information.
